(19) United States
(12) Patent Application Publication
(10) Pub. No.: US 2026/0066633 A1
(43) Pub. Date: Mar. 5, 2026

(54) LONG-STRIP POWER JUNCTION BOX

(71) Applicant: Zhuhai Shengchang Electronics Co., Ltd., Zhuhai City (CN)

(72) Inventors: Jialong HU, Zhuhai City (CN); Dehua ZHENG, Zhuhai City (CN)

(21) Appl. No.: 18/911,208

(22) Filed: Oct. 9, 2024

(30) Foreign Application Priority Data
Aug. 27, 2024 (CN) 2024220906319

(51) Int. Cl. H02G 3/08

(52) U.S. Cl. CPC H02G 3/081

(57) ABSTRACT

The present disclosure discloses a long-strip power junction box, aiming to provide a long-strip power junction box that saves space, is convenient for adjustment of electrical parameters and can be installed in a slender space. The long-strip power junction box includes a main body, which is internally provided with a power chamber and a plurality of wiring chambers, wherein the plurality of wiring chambers are respectively disposed at two ends of the power chamber, and the power chamber is internally provided with a circuit board, an adjustment module and adjusting holes; the circuit board is electrically connected to the adjustment module, and the adjusting holes correspond to the adjustment module; and a cover plate is disposed on the main body and covers the power chamber and the plurality of wiring chambers. The present disclosure is applied to the technical field of power junction boxes.

### TECHNICAL FIELD

The present disclosure relates to the technical field of power junction boxes, in particular to a long-strip power junction box.

### BACKGROUND

In a wiring process, a power junction box can play the roles of protecting wires and connecting the wires. However, when the power junction box is installed, its square shape makes it difficult to install or even impossible to install in the application of a slender space. In addition, the power junction box has the function of adjusting electrical parameters. Since an adjustment module in the prior art is installed at inner sides of wiring chambers in a power junction box, it not only occupies the spaces of the wiring chambers, but also is inconvenient for a user to adjust the electrical parameters.

### SUMMARY

In order to solve the technical problem of overcoming the shortcomings in the prior art, the present disclosure provides a long-strip power junction box that saves space, is convenient for adjustment of electrical parameters and can be installed in a slender space.

The technical solution adopted by the present disclosure is as follows: the present disclosure includes a main body, which is internally provided with a power chamber and a plurality of wiring chambers, where the plurality of wiring chambers are respectively disposed at two ends of the power chamber, and the power chamber is internally provided with a circuit board, an adjustment module and adjusting holes; the circuit board is electrically connected to the adjustment module, and the adjusting holes correspond to the adjustment module; and a cover plate is disposed on the main body and covers the power chamber and the plurality of wiring chambers.

Further, the cover plate includes a power chamber cover plate and an outer cover plate, the power chamber cover plate being configured to cover the power chamber, and the outer cover plate being configured to cover the power chamber cover plate and the plurality of wiring chambers.

Further, the cover plate includes the power chamber cover plate and wiring chamber cover plates with the same number as the wiring chambers, and the power chamber and the wiring chambers are respectively covered with the power chamber cover plate and the wiring chamber cover plates.

Further, the adjusting holes are communicated with the power chamber cover plate.

Further, the adjusting holes are communicated with the interiors of the wiring chambers.

Further, the cover plate is provided with a waterproof pad located inside the main body.

Further, the cover plate is connected to the main body through one of threaded connection, rotary connection, or clamping connection.

Further, two clamping slots are respectively provided at two sides of the main body, and two clamping buckles matched with the clamping slots are respectively disposed at two sides of the cover plate.

Further, there are at least one power chamber and at least two wiring chambers; the power chamber is separated from the adjacent wiring chambers by means of isolation plates; each of the isolation plates is provided with a wire jacket, the wire jacket is provided with threading holes, and the threading holes are configured to enable the power chamber to be communicated with the adjacent wiring chambers.

Further, the plurality of wiring chambers are provided with first knock-out holes; two side plates are respectively disposed at two sides of the main body; and second knock-out holes and mounting holes are reserved in the side plates.

The present disclosure has the following beneficial effects.

Compared with the shortcomings in the prior art, according to the present disclosure, due to the plurality of wiring chambers being respectively disposed at two ends of the power chamber, the main body is enabled to be in a long strip shape, making it easy to install the long-strip power junction box in a slender space; moreover, since the adjustment module is located inside the power chamber, the installation spaces of the wiring chambers can be avoided being occupied, and the adjustment module can be prevented from being affected by cables located in the wiring chambers during adjustment of electrical parameters; and therefore, the present disclosure has the advantages of saving space, facilitating the adjustment of electrical parameters, and being able to be installed in a slender space.

### BRIEF DESCRIPTION OF THE DRAWINGS

In order to more clearly illustrate the embodiments of the present disclosure or the technical solutions in the prior art, a brief introduction will be given to the accompanying drawings required for the description of the embodiments or the prior art. Apparently, the accompanying drawings described below are merely some of the embodiments of the present disclosure, and for those of ordinary skill in the art, without creative efforts, other drawings can also be obtained based on the structures shown in these drawings.

FIG. 1 is a schematic diagram of the three-dimensional structure of Embodiment I of the present disclosure;

FIG. 2 is an exploded view of Embodiment I of the present disclosure;

FIG. 3 is a schematic diagram of the internal structure of Embodiment I of the present disclosure;

FIG. 4 is a schematic diagram of the internal structure of Embodiment II of the present disclosure;

FIG. 5 is a schematic diagram of the three-dimensional structure of Embodiment III of the present disclosure;

FIG. 6 is an exploded view of Embodiment III of the present disclosure;

FIG. 7 is a schematic diagram of the three-dimensional structure of Embodiment IV of the present disclosure; and

FIG. 8 is a schematic diagram of the internal structure of Embodiment IV of the present disclosure.

The implementation, functional characteristics, and advantages of the present disclosure will be further described in detail with reference to the accompanying drawings in conjunction with the embodiments.

### DETAILED DESCRIPTION OF THE EMBODIMENTS

The technical solutions in embodiments of the present disclosure will be described clearly and completely hereinafter with reference to the accompanying drawings in the embodiments of the present disclosure. Apparently, the described embodiments are only a part rather than all of the embodiments of the present disclosure. Based on the embodiments of the present disclosure, all other embodiments obtained by those of ordinary skill in the art without making creative efforts shall fall within the protection scope of the present disclosure.

It should be noted that all directional indications, such as upper, lower, left, right, front, back, clockwise, counterclockwise.. in the embodiments of the present disclosure are only used to explain a relative position relationship and motion situation between components in a specific posture. If the specific posture changes, the directional indication also changes accordingly.

In addition, if there are descriptions related to “first”, “second”, and the like in the present disclosure, the descriptions of “first”, “second”, and the like are only used for descriptive purposes, and cannot be understood as indicating or implying their relative importance or implying the number of indicated technical features. Therefore, the features defined with “first” and “second” may explicitly or implicitly include at least one of these features. In addition, the technical solutions of various embodiments can be combined with each other, which must be based on what those of ordinary skill in the art can achieve. When the combination of the technical solutions is contradictory or impossible to achieve, it should be considered that the combination of such technical solutions does not exist and is not within the scope of protection of the present disclosure.

### Embodiment I

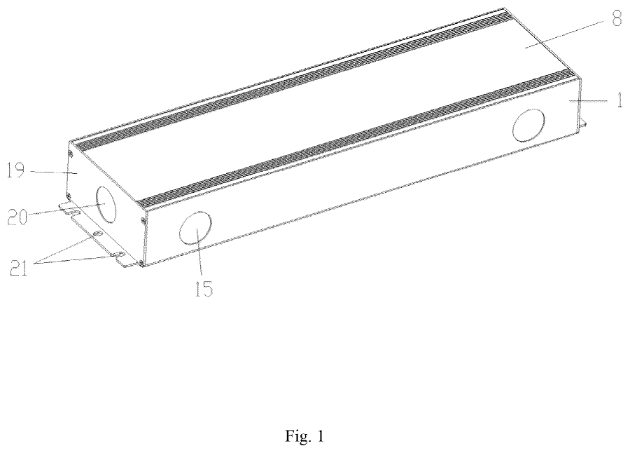

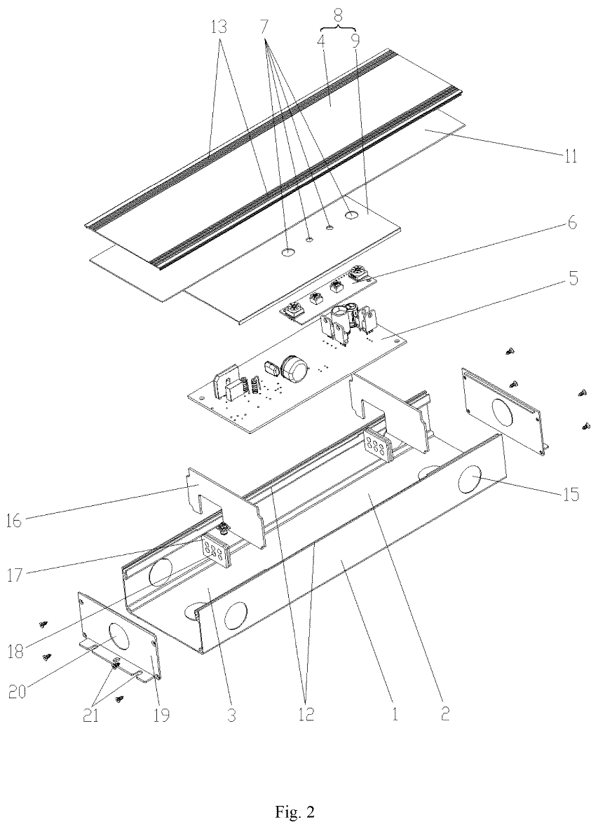

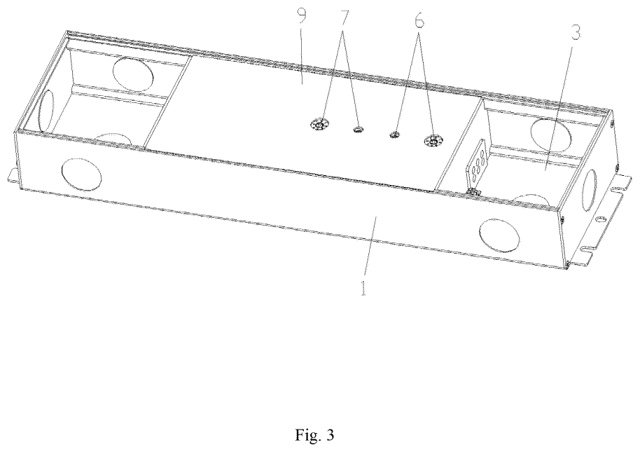

As shown in FIG. 1 to FIG. 3, according to the present disclosure, the present disclosure includes a main body 1, which is internally provided with a power chamber 2 and a plurality of wiring chambers 3, where the plurality of wiring chambers 3 are respectively disposed at two ends of the power chamber 2, and the power chamber 2 is internally provided with a circuit board 5, an adjustment module 6 and adjusting holes 7; the circuit board 5 is electrically connected to the adjustment module 6, and the adjusting holes 7 correspond to the adjustment module 6; and a cover plate 8 is disposed on the main body 1 and covers the power chamber 2 and the plurality of wiring chambers 3.

Compared with the shortcomings in the prior art, according to the present disclosure, due to the plurality of wiring chambers 3 being respectively disposed at two ends of the power chamber 2, the main body 1 is enabled to be in a long strip shape, making it easy to install the long-strip power junction box in a slender space; moreover, since the adjustment module 6 is located inside the power chamber 2, the installation spaces of the wiring chambers 3 can be avoided being occupied, and the adjustment module can be prevented from being affected by cables located in the wiring chambers 3 during adjustment of electrical parameters; and therefore, the present disclosure has the advantages of saving space, facilitating the adjustment of electrical parameters, and being able to be installed in a slender space.

In this embodiment, the cover plate 8 includes a power chamber cover plate 9 and an outer cover plate 4, the power chamber cover plate 9 being configured to cover the power chamber 2, and the outer cover plate 4 being configured to cover the power chamber cover plate 9 and the plurality of wiring chambers 3; and the cover plate 8 is provided with a waterproof pad 11 located inside the main body 1. Specifically, the waterproof pad 11 covers the outer cover plate 4 and is located in the main body 1, thus achieving a waterproof effect.

In this embodiment, the adjusting holes 7 are communicated with the power chamber cover plate 9. Specifically, due to the adjusting holes 7 being communicated with the power chamber cover plate 9, the adjustment module 6 can be directly adjusted through the adjusting holes 7 by simply opening the outer cover plate 4.

In this embodiment, the cover plate 8 is connected to the main body 1 through one of threaded connection, rotary connection, or clamping connection; and two clamping slots 12 are respectively provided at two sides of the main body 1, and two clamping buckles 13 matched with the clamping slots 12 are respectively disposed at two sides of the cover plate 8. Specifically, the cover plate 8 can be clamped on the main body 1 by fitting the clamping slots 12 with the clamping buckles 13, so as to cover the power chamber 2 and the wiring chambers 3.

In this embodiment, there are at least one power chamber 2 and at least two wiring chambers 3; the power chamber 2 is separated from the adjacent wiring chambers 3 by means of isolation plates 16; each of the isolation plates 16 is provided with a wire jacket 17, the wire jacket 17 is provided with threading holes 18, and the threading holes 18 are configured to enable the power chamber 2 to be communicated with the adjacent wiring chambers 3; the plurality of wiring chambers 3 are provided with first knock-out holes 15; two side plates 19 are respectively disposed at two sides of the main body 1; and second knock-out holes 20 and mounting holes 21 are reserved in the side plates 19. Specifically, the wire jackets 17 are mounted on the isolation plates 16, which enables cables to pass through the threading holes 18 available for communicating the power chamber 2 with the adjacent wiring chambers 3, so as to achieve electrical connection; and in addition, the first knock-out holes 15 and the second knock-out holes 20 are provided for the passage of the cables.

### Embodiment II

The difference between Embodiment II and Embodiment I is that: the communicating positions of the adjusting holes 7 in Embodiment II are different, specifically as follows:

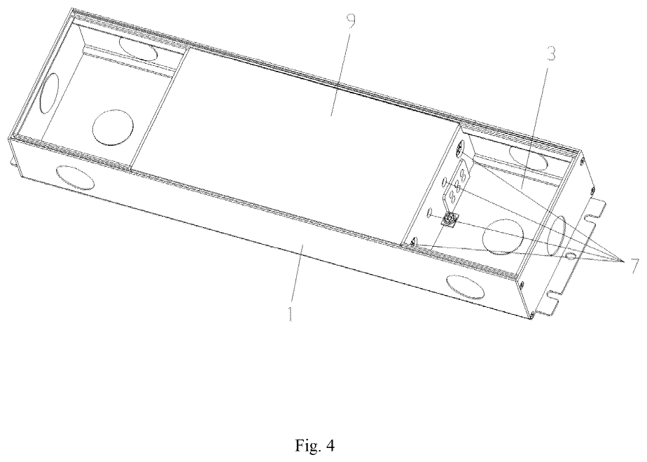

As shown in FIG. 4, in this embodiment, the adjusting holes 7 are communicated with interiors of the wiring chambers 3. Specifically, when electrical parameters need to be adjusted, the outer cover plate 4 is opened, and then the adjustment module 6 located inside the power chamber 2 is adjusted through the adjusting holes 7 located inside the wiring chambers 3.

### Embodiment III

The difference between Example III and Example I is that the specific structure of the cover plate 8 in Example III is different, specifically as follows:

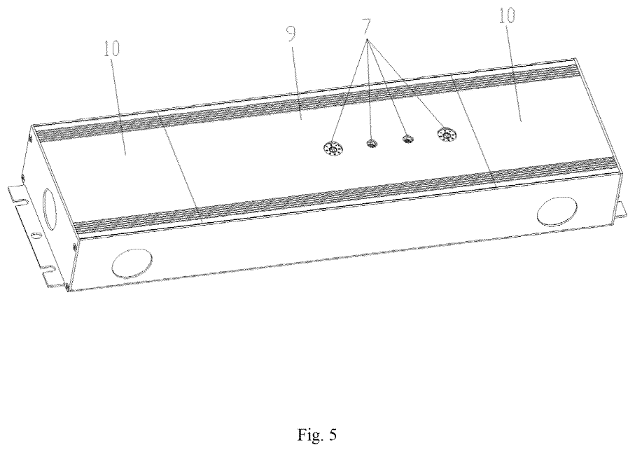

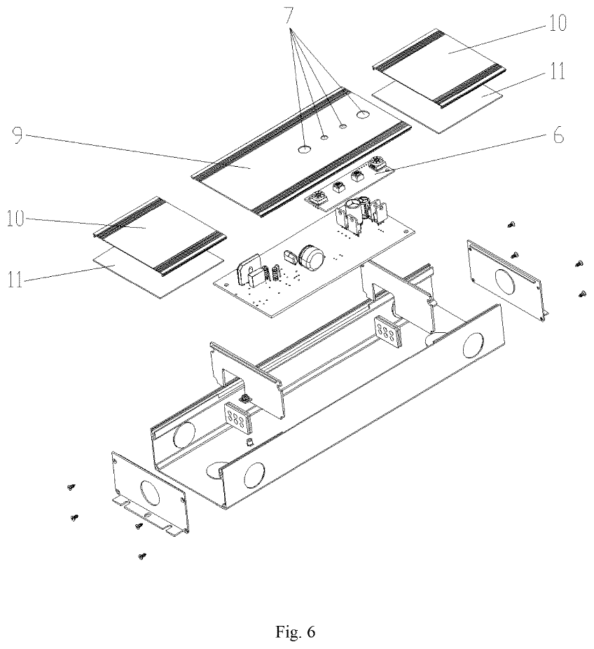

As shown in FIG. 5 to FIG. 6, in this embodiment, the cover plate 8 includes a power chamber cover plate 9 and wiring chamber cover plates 10 with the same number as the wiring chambers 3, and the power chamber 2 and the wiring chambers 3 are respectively covered with the power chamber cover plate 9 and the wiring chamber cover plates 10. Specifically, due to the fact that the cover plate 8 includes the power chamber cover plate 9 and the wiring chamber cover plates 10 with the same number as the wiring chambers 3, both the power chamber 2 and the wiring chambers 3 can be opened independently.

In this embodiment, the adjusting holes 7 are communicated with the power chamber cover plate 9. Specifically, due to the adjusting holes 7 being communicated with the power chamber cover plate 9, the adjustment module 6 can be directly adjusted through the adjusting holes 7 without opening the cover plate 8, so as to further facilitate the adjustment of electrical parameters.

In this embodiment, the cover plate 8 is provided with a waterproof pad 11 located inside the main body 1. Specifically, the waterproof pad 11 is disposed on the wiring chamber cover plate 10 and can cover the wiring chambers 3, thus achieving a waterproof effect.

### Embodiment IV

The difference between Embodiment IV and Embodiment III is that: the communicating positions of the adjusting holes 7 in Embodiment IV are different, specifically as follows:

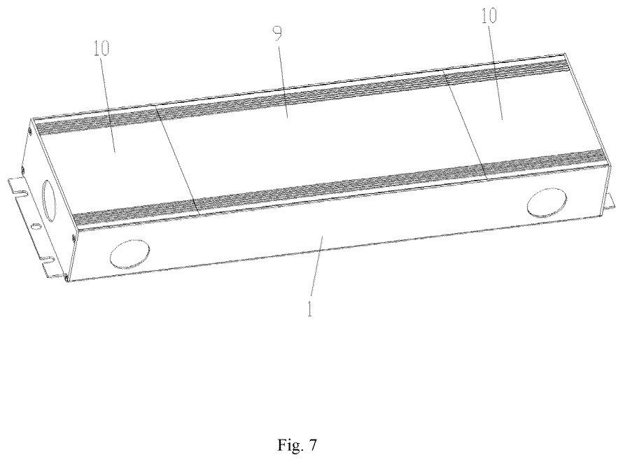

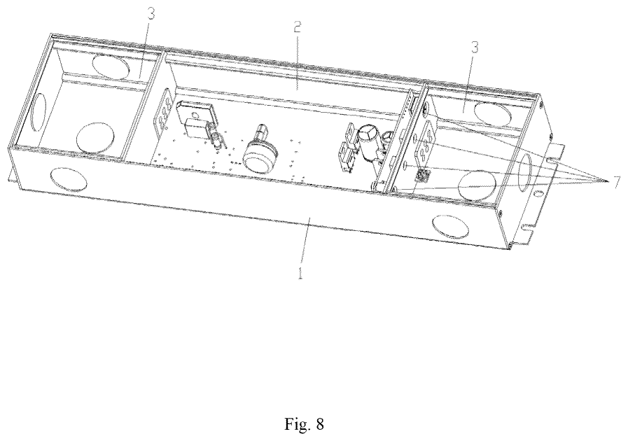

As shown in FIG. 7 to FIG. 8, in this embodiment, the adjusting holes 7 are communicated with the interiors of the wiring chambers 3. Specifically, when electrical parameters need to be adjusted, after the wiring chamber cover plates 10 on the wiring chambers 3 communicated with the adjusting holes 7 are opened, the adjustment module 6 located inside the power chamber 2 is adjusted through the adjusting holes 7 located inside the wiring chambers 3. In this adjustment manner, the electrical parameters can be adjusted without opening the power chamber cover plate 9.

What is claimed is:

1. A long-strip power junction box, comprising: a main body, which is internally provided with a power chamber and a plurality of wiring chambers, wherein the plurality of wiring chambers are respectively disposed at two ends of the power chamber, and the power chamber is internally provided with a circuit board, an adjustment module and adjusting holes; the circuit board is electrically connected to the adjustment module, and the adjusting holes correspond to the adjustment module; and a cover plate is disposed on the main body and covers the power chamber and the plurality of wiring chambers.

2. The long-strip power junction box according to claim 1, wherein the cover plate comprises a power chamber cover plate and an outer cover plate, the power chamber cover plate being configured to cover the power chamber, and the outer cover plate being configured to cover the power chamber cover plate and the plurality of wiring chambers.

3. The long-strip power junction box according to claim 1, wherein the cover plate comprises the power chamber cover plate and wiring chamber cover plates with the same number as the wiring chambers, and the power chamber and the wiring chambers are respectively covered with the power chamber cover plate and the wiring chamber cover plates.

4. The long-strip power junction box according to claim 2, wherein the adjusting holes are communicated with the power chamber cover plate.

5. The long-strip power junction box according to claim 2, wherein the adjusting holes are communicated with the interiors of the wiring chambers.

6. The long-strip power junction box according to claim 2, wherein the cover plate is provided with a waterproof pad located inside the main body.

7. The long-strip power junction box according to claim 2, wherein the cover plate is connected to the main body through one of threaded connection, rotary connection, or clamping connection.

8. The long-strip power junction box according to claim 7, wherein two clamping slots are respectively provided at two sides of the main body, and two clamping buckles matched with the clamping slots are respectively disposed at two sides of the cover plate.

9. The long-strip power junction box according to claim 8, wherein there are at least one power chamber and at least two wiring chambers; the power chamber is separated from the adjacent wiring chambers by means of isolation plates; each of the isolation plates is provided with a wire jacket, the wire jacket is provided with threading holes, and the threading holes are configured to enable the power chamber to be communicated with the adjacent wiring chambers.

10. The long-strip power junction box according to claim 1, wherein the plurality of wiring chambers are provided with first knock-out holes; two side plates are respectively disposed at two sides of the main body; and second knock-out holes and mounting holes are reserved in the side plates.
